(19) United States
(12) Patent Application Publication
(10) Pub. No.: US 2026/0220997 A1
(43) Pub. Date: Jul. 30, 2026

(54) CARD GAME APPARATUS, COMPUTER PROGRAM, AND READABLE RECORDING MEDIUM HAVING COMPUTER PROGRAM RECORDED THEREIN

(71) Applicant: SEGA SAMMY CREATION INC., Tokyo (JP)

(72) Inventors: Hiroyuki MIYANO, Tokyo (JP); Hideki MURATA, Tokyo (JP); Takeshi SHIMA, Tokyo (JP)

(21) Appl. No.: 19/577,362

(22) Filed: Mar. 25, 2026

Related U.S. Application Data
(63) Continuation of application No. PCT/JP2024/044962, filed on Dec. 19, 2024.

(51) Int. Cl. G07F 17/32

(52) U.S. Cl. CPC G07F 17/3211; G07F 17/3293

(57) ABSTRACT

A card game apparatus includes a CPU. The CPU executes display processing of generating an image of a card having a design depicted on a front surface and indicating a card type in a state where the card faces down and is rotated in a rotation orientation in a plane of the card, and a squeezing motion of displaying the image of the card in such a manner that the card is gradually turned face up from an end of the card toward a squeezing direction. A position of the end and the squeezing direction of the card are set in a direction determined for the rotation orientation.

### CROSS-REFERENCE TO RELATED APPLICATIONS

The present application is a continuation application of International Application number PCT/JP2024/044962, filed on Dec. 19, 2024, content of which is incorporated herein by reference in its entirety.

### FIELD

The present disclosure relates to a card game apparatus, a computer program, and a readable recording medium having the computer program recorded therein.

### BACKGROUND

In some card games played in casinos, such as baccarat, a card is dealt face down such that the suit and score on the card surface is not seen, and a game participant then turns the card face up to determine the winner based on the suit and score on the surface of his or her card and those on the surface of the card of an opponent.

When turning over the card, the game participant performs a motion of slowly turning it over from an end (squeezing motion) such that the suit and score on the card surface can be gradually seen, while praying that he or she will win. Turning over the card slowly increases the sense of thrill due to the tension and excitement until the winner is determined, which is one of the most exciting parts of card games.

Patent Literature 1 describes a card game apparatus that enables such a card game to be played not with real cards but in simulation on a screen. This card game apparatus is provided with a touch panel as a display screen, and a user can perform the squeezing motion to a displayed card by sliding his or her finger on the touch panel.

### CITATION LIST

### Patent Literature

Patent Literature 1: International Publication No. WO 2016/185548

### SUMMARY

### Technical Problem

If the card game apparatus described in Patent Literature 1 can also increase the sense of thrill in performing the squeezing motion, the user can enjoy play with a sense even closer to that of a game using real cards.

Thus, an object of the present disclosure is to increase the sense of thrill when a user performs the squeezing motion to a card in a card game apparatus that makes progress of a card game, such as baccarat.

### Solution to Problem

The present disclosure discloses a card game apparatus that includes a CPU. The CPU executes display processing of generating an image of a card having a design depicted on a front surface and indicating a card type in a state where the card faces down and is rotated in a rotation orientation in a plane of the card, and a squeezing motion of displaying the image of the card in such a manner that the card is gradually turned face up from an end of the card toward a squeezing direction, in which a position of the end and the squeezing direction of the card are set in a direction determined for the rotation orientation.

This configuration allows a user to enjoy play with a sense even closer to that of a game using real cards.

In another aspect, the present disclosure provides a program that causes a computer to execute display processing of generating an image of a card having a design depicted on a front surface and indicating a card type in a state where the card faces down and is rotated in a rotation orientation in a plane of the card, and a squeezing motion of displaying the image of the card in such a manner that the card is gradually turned face up from an end of the card toward a squeezing direction, in which a position of the end and the squeezing direction of the card are set in a direction determined for the rotation orientation.

In one aspect, the present disclosure provides a recording medium having the above-described program recorded therein.

Other problems and solutions disclosed in the present application are described in the section of the description of embodiments and the drawings.

### Advantageous Effects of Invention

According to the present disclosure, in the card game apparatus executing a card game, the sense of thrill when a user performs the squeezing motion to a card can be increased.

### BRIEF DESCRIPTION OF DRAWINGS

FIG. 1 is an external perspective view of a card game apparatus according to one embodiment of the present invention.

FIG. 2 is an internal hardware configuration diagram of the card game apparatus according to the present embodiment.

FIG. 3 is a block diagram illustrating a functional configuration of the card game apparatus according to the present embodiment.

FIG. 4 is a diagram illustrating a configuration of card display position data.

FIG. 5 is a diagram illustrating a configuration of card image data.

FIG. 6 is a diagram illustrating a configuration of card shape data.

FIG. 7 is a diagram illustrating a configuration of bet data.

FIG. 8 is a diagram illustrating a configuration of distributed card data.

FIG. 9 is a general flow diagram illustrating an overview of a flow of processing executed from the start until the end of one baccarat game in the card game apparatus according to the present embodiment.

FIG. 10 is a diagram illustrating a state where cards are moved from a banker region of a dealer display device to a user display device and are displayed.

FIGS. 11A and 11B are diagrams illustrating a state where a card displayed on the user display device is rotated on an instruction from a user.

FIG. 12 is a flow diagram of processing executed by a CPU in user distributed card display processing.

FIG. 13 is a flowchart of processing executed by the CPU in card squeezing processing.

FIGS. 14A and 14B are diagrams (part one) for describing how front surfaces are seen when diagonal squeezing is performed to cards from corners on lower sides.

FIGS. 15A and 15B are diagrams (part two) for describing how the front surfaces are seen when the diagonal squeezing is performed to the cards from corners on upper sides.

FIGS. 16A and 16B are diagrams (part one) for describing how the cards are seen when vertical squeezing is performed from the lower sides.

FIGS. 17A and 17B are diagrams (part two) for describing how the cards are seen when the vertical squeezing is performed from the upper sides.

FIGS. 18A and 18B are diagrams for describing how the cards are seen when horizontal squeezing is performed.

### DESCRIPTION OF EMBODIMENTS

Embodiments according to the present invention are described below in detail. The embodiments and modifications below are examples to explain the present invention, and the present invention is not limited only to the embodiments. The present invention can be modified in various ways as long as it does not depart from the gist of the invention. Furthermore, a person skilled in the art can adopt embodiments in which the elements described below are replaced by equivalent ones, and such embodiments are also included in the scope of the invention.

First, the terms used in the present application are explained.

“Baccarat” means a card game exemplified in the present embodiment, in which a user bets on the winner of the card game between a banker (bookmaker) and a player (customer). A dealer deals two or three playing cards to the banker and the player according to the rules of the game. One of the banker and the player whose first digit of the total number on the hand is closer to “9” wins.

“Bet” means predicting whether the banker or the player will win and placing a bet in correspondence with this win and loss prediction.

“Suit” means a mark recorded on the front surface of a card. For example, playing cards described in the present embodiment have four types of suits of spades, hearts, diamonds, and clubs.

“Score” means a numerical value represented by the number of suits or a picture displayed on the front surface of a card. The number of suits represents the score A (=1) or 2 to 10, and the type of the picture represents the score “J” (=11), “Q” (=12), or “K” (=13).

“Card type” means a combination of “suit” and “score” in the present specification because the card type of a card is identified by “suit” and “score” displayed on the card front surface, like “the ace of spades” and “the seven of hearts”.

“Index” means a combination of “suit” and “score” typically written at a corner of a card.

“Squeezing motion” means a motion of turning over an end of a card lying face down such that the back surface can be seen while bending the card with the number at the end of the card hidden (in a real game, with the user hiding the number with his or her finger, in the present embodiment, by generating an image such that the number is not displayed) and making part of the score on the front surface visually recognizable. If the card has a rectangular shape, there are three types of squeezing motions: “diagonal squeezing” of turning over the card from a corner; “vertical squeezing” of turning over the card from the short side; and “horizontal squeezing” of turning over the card from the long side.

“Flip-over motion” means a motion of quickly flipping over a card so that the entire score on the front surface of the card can be seen, without performing the squeezing motion. Performing “squeezing motion” part way and then quickly flipping over a card is also referred to as “flip-over motion”.

Concerning “upward/downward orientation” of a card, the use of rectangular playing cards is assumed in the present embodiment, and one orientation defined by the design (arrangement of a displayed suit or picture) on the front surface is regarded as an upward orientation and the orientation rotated 180° in the card plane from the upward orientation as a downward orientation. If the card is seen on the back surface, “upward/downward orientation” cannot be distinguished between the upward orientation and the downward orientation. Note that the upward/downward orientation of the card front surface may also be incapable of being distinguished because some card types are vertically symmetrical; however, even in that case, either orientation is regarded as “upward orientation”. In accordance with the card orientation, an upper side of the card is defined as “upper side” and a lower side of the card as “lower side”, and “left side” and “right side” are defined in accordance with the positions of the upper side and the lower side.

“Rotation orientation” of a card means an orientation of the card determined by rotation that can be performed to a displayed card vertically, diagonally, and horizontally in steps in the card plane in the present embodiment.

### Configuration of Card Game Apparatus

### External Configuration of Card Game Apparatus

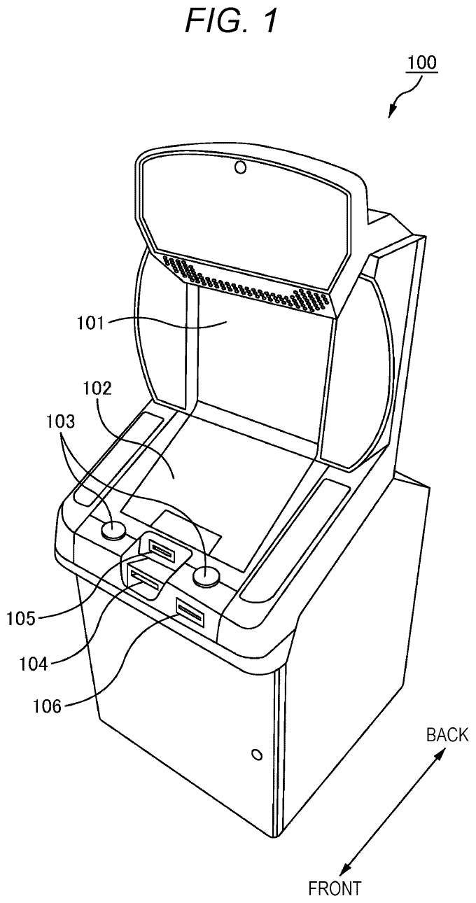

FIG. 1 is an external perspective view of a card game apparatus 100 according to one embodiment of the present invention. The card game apparatus 100 exemplified in FIG. 1 is a game apparatus that is installed in casinos, amusement facilities, or the like and that makes progress of baccarat being an example of the card game. A user can play baccarat using the card game apparatus 100.

As illustrated in FIG. 1, the card game apparatus 100 includes a dealer display device 101 that displays cards on a dealer side (a banker or player side on which the user does not bet), a user display device 102 that displays cards on a user side (a banker or player side on which the user bets), operation buttons 103, a card reading device 104, a banknote insertion device 105, and a ticket dispensing device 106.

The dealer display device 101 is disposed on a back side of the card game apparatus 100 (the upper right side in FIG. 1) while facing a front side (the lower left side in FIG. 1), and the user display device 102 is disposed on the front side while inclining slightly toward the front side from an upward orientation. Note that the user plays the game, sitting on a chair installed in front of the card game apparatus 100 (or standing).

Each of the dealer display device 101 and the user display device 102 is composed of a touch panel, and the user can input an instruction to the card game apparatus 100 by performing operation, such as a touch and a swipe, on a screen.

In this way, by separating a display device into the dealer display device 101 and the user display device 102 and installing the user display device 102 on the front side of the card game apparatus 100, the user can perform the squeezing motion and the like, described later, through the touch panel of the user display device 102 while looking at the cards displayed on the user display device 102 at his or her side and can thus play the game with a sense close to baccarat using real cards.

The operation buttons 103 are physical buttons for inputting an instruction from the user to the card game apparatus 100. In the present embodiment, the operation buttons 103 are used to perform the flip-over motion to a card and are installed on both the right and left sides of the user display device 102 to accommodate right-handed and left-handed users.

The card reading device 104 is a card reader reading information from a card owned by the user. The banknote insertion device 105 is a device reading an inserted banknote or ticket. The ticket dispensing device 106 is a device dispensing a ticket or a banknote to the user. These devices 104 to 106 are used for payment of a stake in betting, payment of a dividend when the game is won, and the like and are not related to the progress of the game, and thus detailed description is omitted.

### Internal Hardware Configuration of Card Game Apparatus

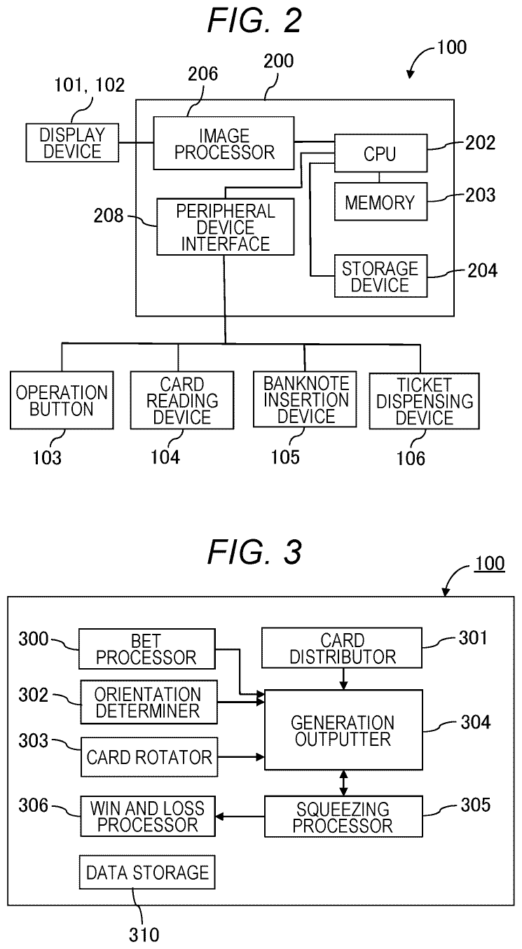

FIG. 2 is an internal hardware configuration diagram of the card game apparatus 100 according to the present embodiment. As illustrated in FIG. 2, the card game apparatus 100 is composed of, as main hardware, a computer 200 including a central processing unit (CPU) 202, a memory 203, a storage device 204, an image processor 206, and a peripheral device interface 208.

The storage device 204 is composed of a recording medium, such as random access memory (RAM), read only memory (ROM), a solid state drive (SSD), or a hard disk. In the storage device 204, a computer program for performing the function as the card game apparatus 100 and data are recorded, and the CPU 202 writes and reads the data to and from the storage device 204 while executing the computer program recorded in the storage device 204, thereby implementing the function as the card game apparatus 100.

Note that, if the storage device 204 is an SSD or a hard disk, the computer program for performing the function as the card game apparatus 100 may be installed from a DVD, flash memory, or the like into the storage device 204. Alternatively, the storage device 204 may include a drive device capable of reading data from a DVD or flash memory, and the computer program read from the DVD, flash memory, or the like may be executed.

The image processor 206 generates a graphic image to be displayed on the dealer display device 101 and the user display device 102 under control of the CPU 202.

The peripheral device interface 208 enables communications between the CPU 202 and peripherals, such as the operation buttons 103, the card reading device 104, the banknote insertion device 105, and the ticket dispensing device 106.

### Functional Configuration of Card Game Apparatus

FIG. 3 is a block diagram illustrating a main functional configuration of the card game apparatus 100 according to the present embodiment. As illustrated in FIG. 3, the card game apparatus 100 includes functional units that are a bet processor 300, a card distributor 301, an orientation determiner 302, a card rotator 303, a generation outputter 304, a squeezing processor 305, and a win and loss processor 306, and a data storage 310.

The bet processor 300 receives a target of a bet (whether the user bets on the player or the banker) and an amount of the bet by the user and stores the bet details in the data storage 310.

The card distributor 301 determines the card types to be dealt to the player and the banker and stores the determined card types in the data storage 310.

The orientation determiner 302 randomly determines the upward/downward orientations of cards when the cards are displayed on the user side and stores the determined upward/downward orientations in the data storage 310.

The card rotator 303 rotates a card in the card plane in response to an instruction from the user and stores the rotation orientation in the data storage 310.

The generation outputter 304 generates a card display screen on which the cards of the bet target received by the bet processor 300 are displayed face down in the upward/downward orientations determined by the orientation determiner 302 and the orientation of the rotation at the card rotator 303 and outputs the card display screen to the user display device 102 for display.

The squeezing processor 305 updates card images on the card display screen generated by the generation outputter 304 in response to the squeezing motion and the flip-over motion on the screen of the user display device 102. The squeezing processor 305 also performs update processing of a card screen displayed on the dealer display device 101 in response to the flip-over motion to the cards on the dealer side.

When all the cards are turned face up, the win and loss processor 306 determines the winner between the player and the banker according to the rules of baccarat, and, if the side on which the user side bets wins, performs dividend payment processing.

The data storage 310 is provided in the storage device 204. When the CPU 202 performs processing for implementing each of the above-described functional units, the data storage 310 is referred to, or data is written and updated. In the data storage 310, display position data 311, card image data 312, card shape data 313, bet data 314, and distributed card data 315 are stored. Among these, the display position data 311, the card image data 312, and the card shape data 313 are pre-set fixed data, and the bet data 314 and the distributed card data 315 are variable data changed as the game progresses.

### Data Configuration

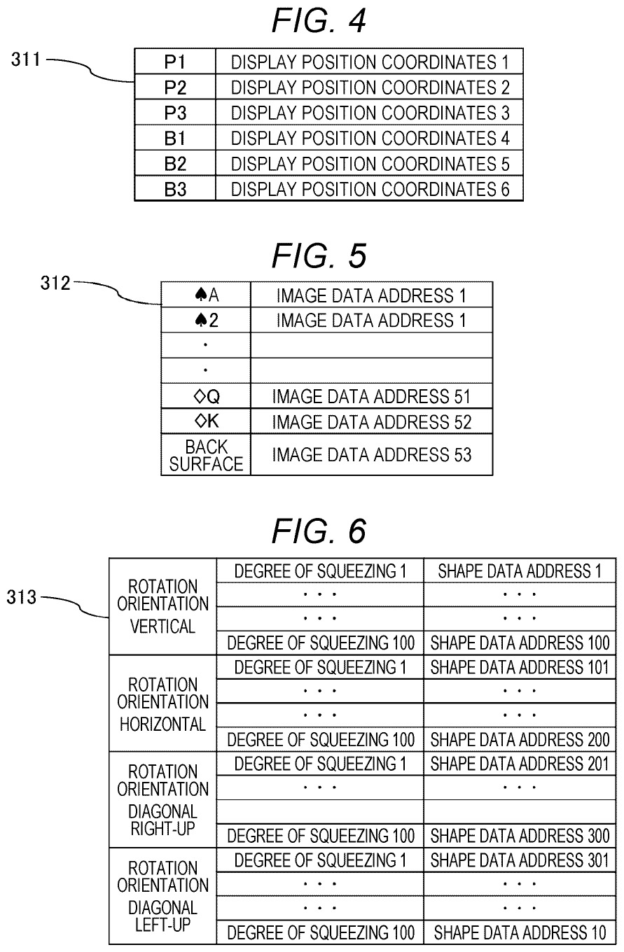

FIG. 4 is a diagram illustrating a configuration of the display position data 311.

As illustrated in FIG. 4, display position coordinates of each of three cards dealt to the player (hereinafter referred to as cards P1 to P3) and three cards dealt to the banker (hereinafter referred to as cards B1 to B3) on the display screens in the display position data 311 are preliminarily stored in the storage device 204. Note that the display position coordinates may be any that can identify a card display position, such as barycentric position coordinates of a card or position coordinates of a specific corner. If the barycentric position coordinates, which do not change the position even if the card is rotated, are used, a common card display position can be set for a plurality of rotation orientations of the card. Each card is displayed on any of a player region 101a and a banker region 101b of the dealer display device 101 and a display region of the user display device 102. If the display position coordinates in the display position data 311 of a card indicate relative position coordinates from a specific position in each region, position coordinates common to these regions can be set.

FIG. 5 is a diagram illustrating a configuration of the card image data 312. As illustrated in FIG. 5, to the card image data 312, an address (or a file name) of image data indicating each of front surface designs of a total of 52 card types being combinations of the 4 types of suits and the 13 types of scores and a card back surface design is pre-set. The card back surface design is vertically and horizontally symmetrical, and card orientations cannot be known on the back surface. Note that the image data themselves of the cards are preliminarily stored in the storage device 204.

FIG. 6 is a diagram illustrating a configuration of the card shape data 313. As illustrated in FIG. 6, to the card shape data 313, data (configured by, for example, polygonal data) indicating a card outline shape in a squeezed state for each value (as described later, 0 to 100 in the present embodiment) of the degree of squeezing to a card in each of cases where the rotation orientations in displaying the card are “Horizontal”, “Vertical”, “Diagonal right-up”, and “Diagonal left-up” is set. Note that the shape data corresponding to the degree of squeezing is stored for each rotation orientation of a card because, as described later, display of the card can be rotated vertically, horizontally, diagonally right-up, and diagonally left-up, and a portion and a direction in which the squeezing motion is performed to the card differ depending on the rotation orientation.

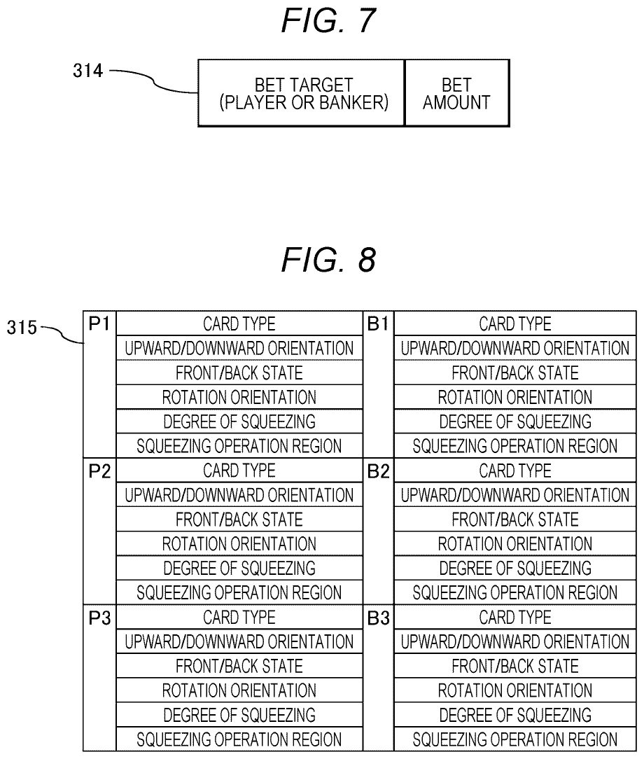

FIG. 7 is a diagram illustrating a configuration of the bet data 314. As illustrated in FIG. 7, the bet data 314 contains the bet target (the player or the banker) and the amount of the bet by the user.

FIG. 8 is a diagram illustrating a configuration of the distributed card data 315. As illustrated in FIG. 8, the distributed card data 315 contains the following items for each of the cards P1 to P3 dealt to the player and the cards B1 to B3 dealt to the banker. Note that the cards P3 and B3 are handled when the third card is dealt according to the rules of baccarat, and, at the beginning of the game, the items for the cards P3 and B3 are not set (blank).
“Card type” indicates a combination of the suit (spades, clubs, diamonds, hearts) and the score (A, 2 to 10, J, Q, K), and its default value is blank.
“Upward/downward orientation” indicates whether the card is displayed in the upward orientation or the downward orientation, and its default value is “Upward” (upward orientation).
“Front/back state” indicates whether the card is displayed face up or down, and its default value is “Back” (face down).
“Rotation orientation” indicates in which rotation orientation the card is displayed. The card displayed on the user display device 102 can be rotated, for example, vertically, horizontally, diagonally right-up, and diagonally left-up in steps on the screen on an instruction from the user. In the present embodiment, the rotation orientation is indicated in six steps, D1 to D6, and its default value is D1.
“Degree of squeezing” indicates a degree of squeezing in the squeezing motion performed by the user by swiping the card displayed on the user display device 102, for example, by using a numerical value from 0 to 100. The value “0” of “Degree of squeezing” indicates a state where no squeezing motion is performed, and the value “100” indicates a state where the maximum squeezing is performed. If the squeezing motion is further performed from the state with the value “100”, “Front/back state” of the card becomes “Front”. The default value of “Degree of squeezing” is “0”. Note that the steps 0 to 100 for the degree of squeezing are merely examples, and the number of steps may be set such that changes in a card image with the squeezing motion are subtle enough to be seen continuously.
Concerning “Squeezing operation region R”, for each card displayed on the user display device 102, data identifying a region where the squeezing motion can be performed is stored. Note that, in the present embodiment, the value of “Squeezing operation region R” is set for each value of “Rotation orientation” of a card, which can handle cases of different regions where the squeezing motion is performed depending on the orientation of the displayed card.

### General Overview of Processing

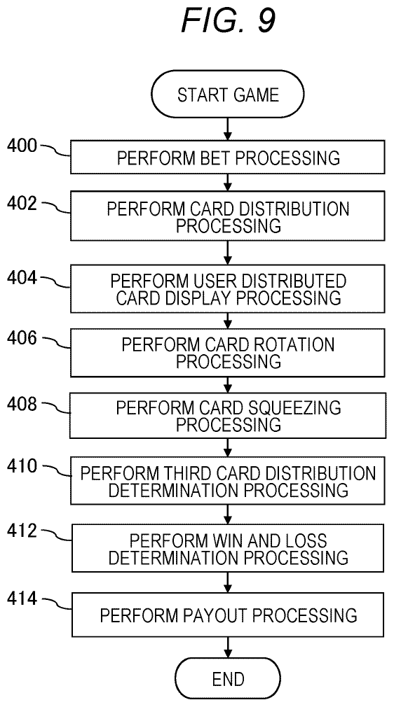

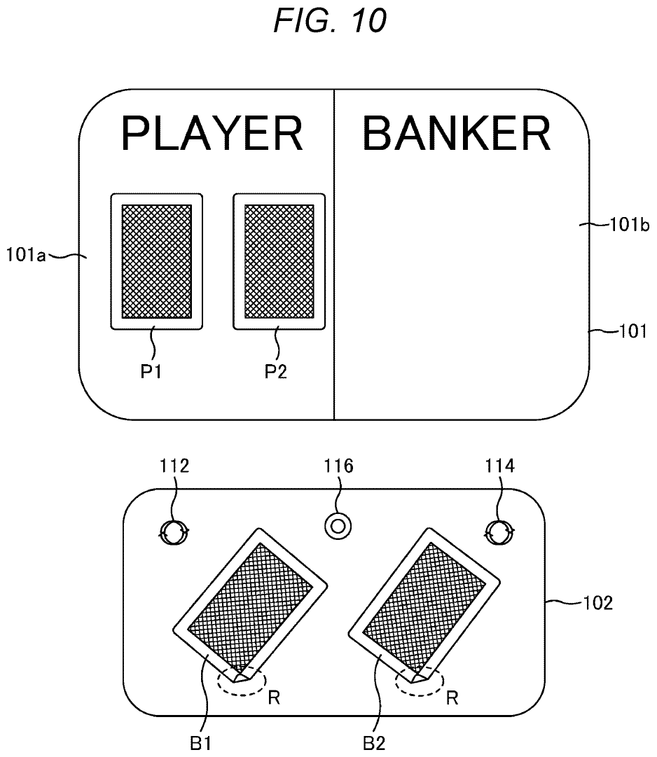

FIG. 9 is a general flow diagram illustrating an overview of a flow of processing executed from the start until the end of one round of play of a baccarat game in the card game apparatus 100.

### Bet Processing

As illustrated in FIG. 9, first, at Step 400, bet processing is performed in which the user places a bet.

To be specific, the CPU 202 reads bet screen data preliminarily stored in the storage device 204 and displays a bet screen on the user display device 102. On this bet screen, the user can select whether to bet on the banker or the player and can set a stake amount. If the user places a bet on the bet screen, the CPU 202 stores details of the bet by the user (the banker or the player on which the bet is placed and the amount of the bet) as the bet data 314 in the data storage 310. The bet processor 300 illustrated in FIG. 3 corresponds to the CPU 202 performing the bet processing at Step 400.

### Card Distribution Processing

Next, at Step 402, card distribution processing is performed in which cards to be dealt to the banker and the player are determined and displayed in the player region 101a and the banker region 101b of the dealer display device 101.

To be specific, the CPU 202 randomly determines card types of the two cards P1 and P2 to be dealt to the player and the two cards B1 and B2 to be dealt to the banker while avoiding duplication. To be specific, for example, a card type 1 of the card P1 is first determined among all 52 card types by a random number, and a card type 2 of the card P2 is then determined among 51 card types excluding the determined card type 1 by a random number. Thereafter, similarly, a card type 3 of the card B1 and a card type 4 of the card B2 are sequentially determined among the card types excluding the determined card types by random numbers. Then, the determined card types 1 to 4 of the cards P1, P2, B1, and B2 are stored as the values of the item “Card type” for the respective cards P1, P2, B1, and B2 in the data storage 310.

Then, the CPU 202 displays the two cards face down in each of the player region 101a and the banker region 101b of the dealer display device 101.

Note that the card distributor 301 illustrated in FIG. 3 corresponds to the CPU 202 performing the card distribution processing at Step 402.

### User Distributed Card Display Processing

Next, at Step 404, user distributed card display processing is performed in which the cards of the banker or the player on which the user bets are moved from the dealer display device 101 to the user display device 102 and are displayed while facing down.

FIG. 10 is a diagram illustrating a state where the user bets on the banker and the cards are moved from the banker region 101b of the dealer display device 101 to the user display device 102 and are displayed through the user distributed card display processing at Step 404.

As illustrated in FIG. 10, the display screen of the dealer display device 101 is provided with the player region 101a and the banker region 101b. In FIG. 10, on the assumption that the user has placed a bet, display of the cards in the banker region 101b on the banker side is erased, and the two cards B1 and B2 of the banker are displayed face down on the user display device 102 with only ends (in FIG. 10, corners at lower ends in the drawing) turned face up. Note that, in FIG. 10, the cards B1 and B2 are displayed in the diagonal right-up rotation orientation on the user display device 102, and how the rotation orientation of a card is determined is described later.

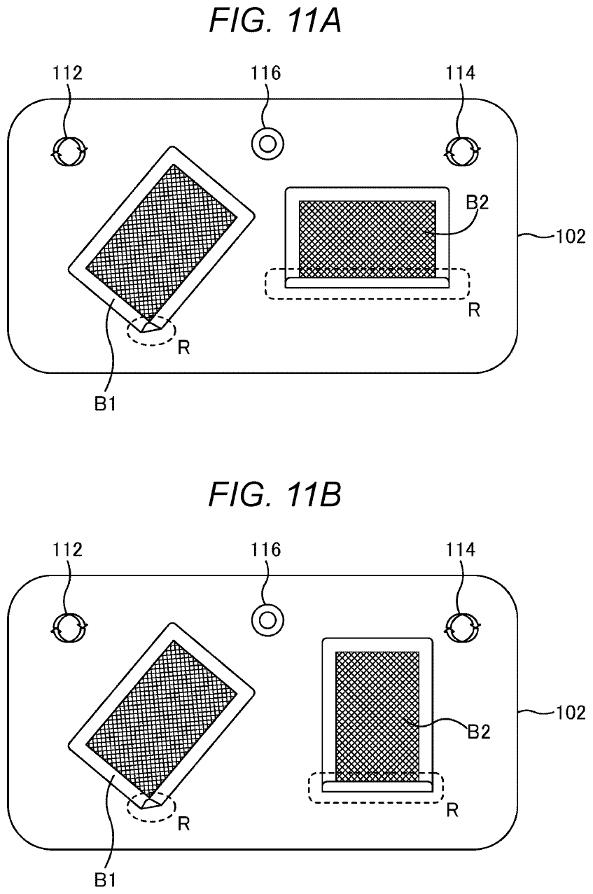

As illustrated in FIG. 10, card rotation icons 112 and 114 corresponding to the two cards B1 and B2 are displayed on the user display device 102. If the card rotation icon 112 or 114 is touched, the corresponding card rotates in a vertical, horizontal, diagonal left-up, or diagonal right-up direction. FIGS. 11A and 11B illustrate states where the card B2 is rotated on an instruction from the user.

As illustrated in FIGS. 10, 11A, and 11B, a folded position of an end of a card displayed on the user display device 102 changes among a corner (the cards B1 and B2 in FIG. 10), a long side (the card B2 in FIG. 11A), and a short side (the card B2 in FIG. 11B) depending on the rotation orientation of the card, and an end of the card on the front side in screen display, that is, an end positioned on the front side when viewed from the user is always displayed in a folded state.

The CPU 202 sets the squeezing operation regions R at the folded portions of the cards B1 and B2 and their vicinities, that is, part of the cards or/and vicinities of the cards, on the user display device 102. Note that the squeezing operation regions R are not visible to the user but are illustrated with dotted lines in each drawing to facilitate understanding. The squeezing operation regions R differ in position and shape depending on the card rotation orientation. By the user providing an instruction, such as a swipe, to the squeezing operation region R, the squeezing motion to the card is performed.

Display of the cards with their lower portions turned at the time of distributing the cards to the user display device 102 indicates, to the user, the positions where the squeezing motion is performed and also has an effect of promoting the squeezing motion.

### Details of User Distributed Card Display Processing

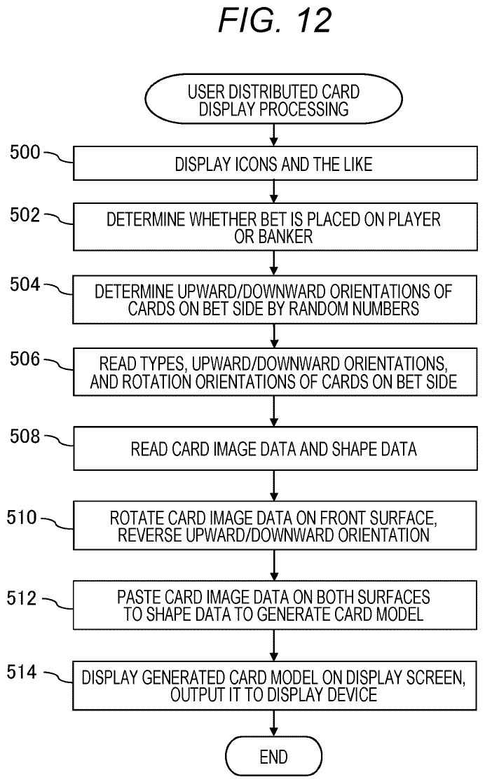

FIG. 12 is a flow diagram illustrating processing executed by the CPU 202 in the user distributed card display processing at Step 404 in more detail.

First, at Step 500, the CPU 202 displays the card rotation icons 112 and 114, a flip-over icon 116, and other decorative designs in predetermined positions on the user display device 102.

Next, at Step 502, the CPU 202 refers to the bet data 314 illustrated in FIG. 7 to determine whether the user bets on the player or the banker. In the following description, assume that the user bets on the banker.

Next, at Step 504, for each of the cards B1 and B2 of the banker, on which the user bets, the upward/downward orientation (“Upward” or “Downward”) is determined by a random number and is recorded as the value of the item “Upward/downward orientation” in the distributed card data 315 illustrated in FIG. 8.

Note that the orientation determiner 302 for cards in FIG. 3 corresponds to the CPU 202 performing the processing at Step 504.

Next, at Step 506, for the cards B1 and B2 of the banker, on which the bet is placed, each value of the items “Card type”, “Upward/downward orientation”, and “Rotation orientation” is read by referring to the distributed card data 315 illustrated in FIG. 8. Note that, as described later, the rotation orientation when the first squeezing motion is performed in previous play is stored in the item “Rotation orientation”.

Next, at Step 508, by referring to the card image data 312 illustrated in FIG. 5, image data A corresponding to the value of the item “Card type” read from the distributed card data 315 and image data B corresponding to “Back surface” are read. Furthermore, by referring to the card shape data 313 illustrated in FIG. 6, shape data corresponding to the value “0” of “Degree of squeezing” in “Rotation orientation” read from the distributed card data 315 is read. As described above, the value “0” of “Degree of squeezing” indicates the state where no squeezing motion is performed, and, to be specific, indicates a state where an end of the card is turned slightly to the extent that the suit and the score design on the card front surface is not seen, like the cards B1 and B2 displayed on the user display device 102 in FIGS. 10, 11A, and 11B.

Next, at Step 510, the image data A is rotated in accordance with the value of “Rotation orientation”, and, if the value of “Upward/downward orientation” is “Downward”, the upward/downward orientation is reversed. Then, at Step 512, the image data A and the image data B are pasted on the front surface and the back surface of the card shape data read at Step 508 to generate a card model.

Next, at Step 514, a display screen displaying the generated card model with the card back surface visible is generated and output to the user display device 102.

As described above, at Step 504, the upward/downward orientation of the card is randomly determined, but, at Step 514, the card is displayed face down, so that the user does not know the upward/downward orientation of the card at this stage. The significance of random determination of the upward/downward orientation of the card displayed on the user display device 102 is described later.

Note that the generation outputter 304 for card display screens in FIG. 3 corresponds to the CPU 202 performing the user distributed card display processing at Step 404.

### Card Rotation Processing

After the user distributed card display processing at Step 404 in FIG. 9 is performed, card rotation processing is then performed at Step 406.

As described above, the card rotation icons 112 and 114 corresponding to the two cards B1 and B2 are displayed on the display screen of the user display device 102. If the card rotation icon 112 or 114 is touched, the corresponding card B1 or B2 rotates in the vertical, horizontal, diagonal left-up, or diagonal right-up direction. That is, if the right card rotation icon 114 is touched with the card diagonal right-up like the cards B1 and B2 illustrated in FIG. 10, the right card B2 rotates clockwise to a horizontally oriented state as illustrated in FIG. 11A. If the card rotation icon 114 is touched from this state, the card is in a diagonal left-up state. Furthermore, if the card rotation icon 114 is touched from this state, the card B2 is in a vertically oriented state as illustrated in FIG. 11B.

In the card rotation processing, each time the card rotation icon 112 or 114 is touched, the CPU 202 updates, for the corresponding card B1 or B2, the value of the item “Rotation orientation” in the distributed card data 315 from a current value to a next value of the rotation orientation (for example, if the current value is D1, it is updated to D2). Then, the displayed card is erased, and, similar to the processing at Step 512 (FIG. 12) in the user distributed card display processing, a card model corresponding to the updated rotation orientation is generated and displayed on the user display device 102.

Note that the card rotator 303 in FIG. 3 corresponds to the CPU 202 performing the card rotation processing at Step 406.

Note that, until starting the squeezing motion, described later, the user can perform the rotation operation on either of the two cards B1 and B2, and the rotation orientation of a card to which the squeezing motion is performed first (the rotation orientation at the time of performing the squeezing motion) is stored in the item “Upward/downward orientation” for all the cards P1 to P3 and B1 to B3 in the distributed card data 315.

This allows the rotation orientations of the cards displayed on the user display device 102 when a next game is played to be the same as the rotation orientation of the card to which the squeezing motion is performed first in a current game, regardless of whether a bet is placed on the player or the banker.

A portion of a card where the squeezing motion of the card is started changes depending on the card orientation among a corner, a long side, and a short side of the card, and users, especially those accustomed to playing the game, often have a preference as to which portion of a card is squeezed first. In that case, when playing the first game, the user needs to rotate the cards in a preferred orientation if the cards are not dealt in an orientation where the squeezing motion can be performed from a preferred portion.

In contrast, in the present embodiment, in the user distributed card display processing in next play, the cards can be dealt in the same rotation orientation as that of the cards set by the user in current play, that is, in an orientation matching the user's preference, so that it is unnecessary for the user to perform the rotation operation on the cards in each round of play.

### Card Squeezing Processing

After the card rotation processing at Step 406 is performed, card squeezing processing is then performed at Step 408. In the card squeezing processing, a state where a card displayed on the user display device 102 is gradually turned over to gradually reveal the front surface in accordance with the squeezing motion by the user is displayed (that is, squeezing display). Note that, if the squeezing motion to a card is detected without the card rotation icons 112 and 114 touched, the card squeezing processing at Step 408 is performed to the card without the rotation processing at Step 406 performed.

### Card Flip-Over Processing

In the card squeezing processing at Step 408, flip-over processing of turning a card face up immediately without squeezing is also performed. First, the flip-over processing is described.

In the flip-over processing, each time the user presses the operation button 103, the flip-over processing to a card displayed on the dealer display device 101 is performed one by one. If the flip-over icon 116 is touched, the flip-over processing to a card displayed on the user display screen is performed, and this processing can be performed even during the card squeezing motion.

To be specific, if detecting that the operation button 103 is pressed, the CPU 202 displays cards displayed in the player region 101a of the dealer display device 101 face up one by one, referring to “Card type” in the distributed card data 315 and the card image data 312. If a touch to the flip-over icon 116 is detected, a card displayed on the user display device 102 is displayed face up. For the card displayed face up, “Front/back state” in the distributed card data 315 is updated to “Front”.

Note that a state where a card is being turned over from the back side to the front side may be displayed with an animation as if the squeezing motion is performed to increase the sense of realism close to a game using real cards.

### Details of Card Squeezing Processing

Next, details of the card squeezing processing are described.

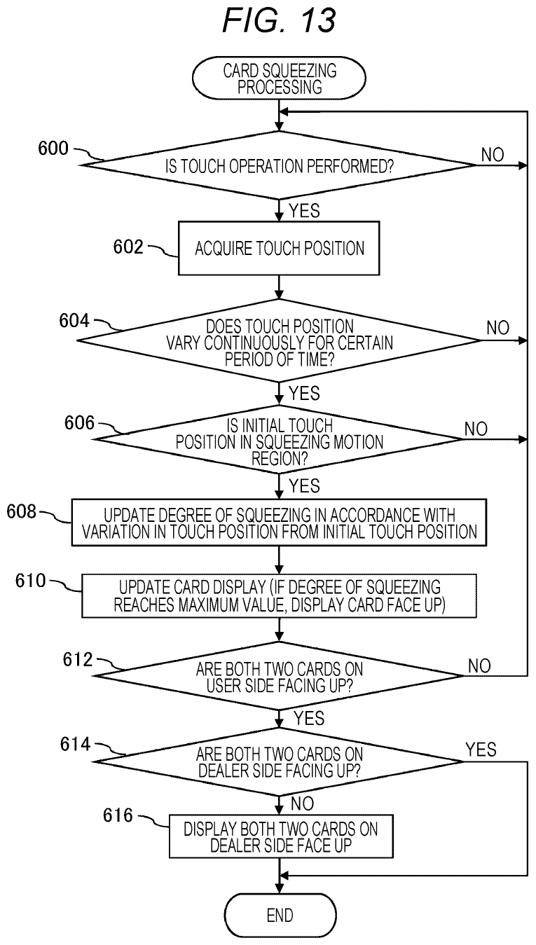

FIG. 13 is a flow diagram illustrating details of processing executed by the CPU 202 in the card squeezing processing.

First, the CPU 202 determines whether the user performs the squeezing motion to the card B1 or B2.

To be specific, the touch panel composing the user display device 102 is configured to, if detecting touch operation on the screen, supply coordinate information of the touch position to the CPU 202, and the CPU 202 determines whether touch operation is performed on the basis of whether the coordinate information of the touch position is supplied from the touch panel at Step 600.

If it is determined at Step 600 that touch operation is performed, the coordinate information of the touch position is acquired at Step 602. On the other hand, if it is determined that no touch operation is performed, the processing at Step 600 is repeated.

Next, at Step 604, it is determined whether the touch position varies continuously for a certain period of time. If it is determined that the touch position varies continuously, it is determined at Step 606 whether the position where the touch starts (touch start position) is contained in the item “Squeezing operation region R” for the card B1 or B2, referring to the distributed card data 315. If the position is contained in “Squeezing operation region R”, it is determined that the squeezing motion is performed to the card B1 or B2. However, if the item “Front/back state” for the card B1 or B2 indicates front, the squeezing motion is invalid because it indicates that the card facing up is swiped. If negative determination is made at Step 604 or 606, or if it is determined that the squeezing motion is invalid, the procedure returns to Step 600. Note that the sizes of “Squeezing operation region R” illustrated in the drawings are examples, and various shapes and/or sizes may be set in accordance with the state and design of the game.

Assume that it is determined that the squeezing motion is performed to either card at Step 606 (the card to which the squeezing motion is performed is hereinafter referred to as “card of interest”). Next, at Step 608, the value of the item “Degree of squeezing” for the card of interest in the distributed card data 315 is increased or decreased in accordance with a difference between an initial touch position and a current touch position supplied from the touch panel. To be specific, if the touch position varies toward the back side when viewed from the user (in a squeezing direction), the value is increased by “1”. If it varies toward the front side when viewed from the user (in a squeezing return direction), the value is decreased by “1”. With this, if the card of interest is swiped upward, the degree of squeezing is increased as the squeezing motion progresses, and, if the swipe operation is performed downward, the degree of squeezing is decreased as the squeezing motion is withdrawn. Note that the increase and decrease range of “Degree of squeezing” may be greater as the speed of the squeezing motion (swipe speed) is faster, in accordance with the speed.

Then, at Step 610, the displayed card of interest is erased, and similar to the processing at Step 510 (FIG. 12) in the user distributed card display processing, a card model corresponding to “Degree of squeezing”, “Rotation orientation”, and “Upward/downward orientation” after the update is generated and displayed on the user display device 102. This allows display of the card of interest to be updated in accordance with the squeezing motion and enables a state similar to squeezing of a real card to be reproduced with graphics, which can provide a true-to-life feeling similar to play with real cards to the user.

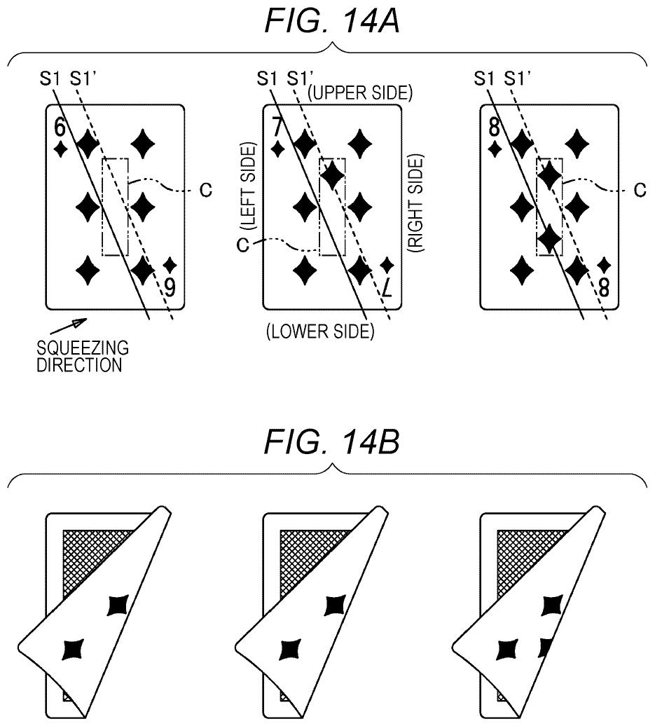

Note that, in the card squeezing processing, when the cards are displayed, the indices (suits and scores) drawn in the vicinities of the corners on the card front surfaces are not displayed as illustrated in the drawings B in FIGS. 14A to 18B. This prevents the card type from being known immediately after the squeezing motion is started.

If the value of “Degree of squeezing” exceeds a certain threshold at Step 610, processing of displaying the card of interest face up is executed. “Degree of squeezing” correlates with the area of a turned portion of a card. Thus, it can also be understood that the processing of displaying the card of interest face up is executed if the turned area of a card exceeds the threshold in other words. For example, if the threshold is pre-set at 80 and if the value of “Degree of squeezing” is 81 at Step 610, the CPU 202 displays the card of interest face up and updates the value of the item “Front/back state” in the distributed card data 315 to front. This ends the squeezing motion to the card of interest.

It is desirable that the threshold to be compared with “Degree of squeezing” be a value to reach the degree of squeezing at which the card type of the card of interest becomes clear. This threshold may be set for each card type. This is because the degree of squeezing at which the card type becomes clear differs depending on the score or suit of the card or a combination thereof in some cases.

Alternatively, the degree of squeezing at the time when the user increases the swipe speed can also be set as the threshold. When ending the squeezing motion, the user typically increases the swipe speed to end the squeezing motion quickly. By storing the degree of squeezing preferred by the user, prompt game processing in accordance with the user can be executed.

Note that, if the value of “Degree of squeezing” reaches a maximum value (100 in the present embodiment) at Step 610, the card of interest may be displayed face up, and the value of the item “Front/back state” in the distributed card data 315 may be updated to front.

At Step 612 following Step 610, “Front/back state” in the distributed card data is determined for the cards B1 and B2 on the user side. If “Front/back state” for one or both of the cards B1 and B2 on the user side is “Back” as a result, the procedure returns to Step 600 to continue the card squeezing processing.

On the other hand, if “Front/back state” for both the two cards is “Front” at Step 612, it is determined whether “Front/back state” for both the cards P1 and P2 on the dealer side is “Front” at Step 614. If “Front/back state” for one or both is “Back”, the card or cards are displayed face up at Step 616, “Front/back state” in the distributed card data 315 is updated to “Front”, and the card squeezing processing ends. If “Front/back state” for both the cards P1 and P2 is “Front” at Step 614, the card squeezing processing ends as is.

Note that the squeezing processor 305 illustrated in FIG. 3 corresponds to the CPU 202 performing the card squeezing processing illustrated in FIG. 13.

After the card squeezing processing illustrated in FIG. 13 ends, the procedure then proceeds to Step 410 in FIG. 9.

At Step 410, on the basis of the scores of the cards P1 and P2 on the dealer side and the cards B1 and B2 on the user side, which have been turned face up, it is determined whether a third card is dealt to each of the banker and the player according to the rules of baccarat. If it is determined that the third card is dealt, a card to be dealt is determined and displayed face down, and the card squeezing processing is performed, in the same manner as at Steps 402 to 408.

Next, at Step 412, the winner is determined according to the rules of baccarat on the basis of the scores of the two or three cards dealt to each of the banker and the player and turned face up.

Finally, at Step 414, if the side on which the user bets wins between the banker and the player, the payout processing of a dividend being the product of the amount of the bet multiplied by a predetermined multiplier is performed, and the current game ends.

### Significance and Effect of Pre-Setting Squeezing Direction of Distributed Card

As described above, in the card game apparatus 100 of the present embodiment, in the distributed card display processing at Step 404 in FIG. 9, when a card on the side on which the user bets is displayed on the user display device 102, the squeezing direction is pre-set, and its significance and effect are described.

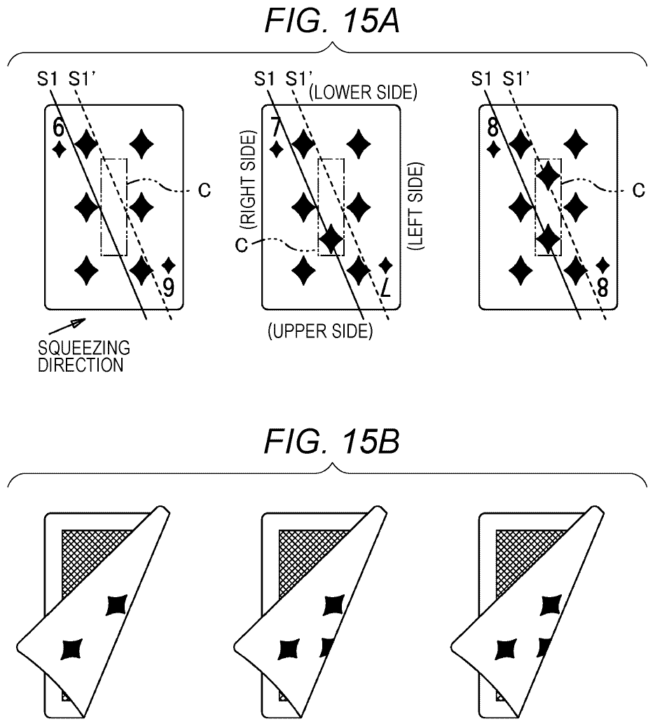

FIGS. 14A, 14B, 15A and 15B are diagrams for describing how front surfaces are seen when the diagonal squeezing is performed to cards from lower corners.

FIGS. 14A and 15A illustrate states where the entire card front surfaces of the six of diamonds, the seven of diamonds, and the eight of diamonds are displayed, and FIGS. 14B and 15B illustrate states where, from states where the back surfaces of these cards are displayed, the diagonal squeezing is performed from corners to the positions of solid lines S1 illustrated in FIG. 14A to reveal part of the designs on the front surfaces.

FIG. 14A illustrates a case where the cards are dealt in such a manner that the diamond mark in the central row of the seven of diamonds is arranged on the back side when viewed from the user, in other words, the upper side of the card is positioned on the back side. As illustrated in FIG. 14A, the card with the six of diamonds has such a design that three vertically-aligned diamond marks are displayed in each of two longitudinal rows, the card with the seven of diamonds has such a design that one diamond mark is further displayed close to either the upper or lower side in the central row, and the card with the eight of diamonds has such a design that two diamond marks are symmetrically displayed close to both the upper and lower sides in the central row. Except for the indices, to distinguish among the six of diamonds, the seven of diamonds, and the eight of diamonds in this way, it is necessary to check whether the diamond mark/marks in the central row is/are displayed. In the following description, a portion, of each card, being a ground for distinction to the other cards is referred to as a distinctive portion C.

With the diagonal squeezing performed as in FIG. 14B, two among the three diamond marks aligned in one of the rows are visible on all the cards with the six, seven, and eight of diamonds, and, in addition to this, a diamond mark in the central row starts to be visible on the eight of diamonds. Thus, if it is known that the card is dealt in the orientation as in FIG. 14A, the card can be confirmed to be the eight of diamonds at this stage; however, if the diamond mark in the central row is not visible in the distinctive portion C, whether it is the six of diamonds or the seven of diamonds cannot be confirmed.

On the other hand, if, as illustrated in FIG. 15A, the seven of diamonds is dealt upside down from that in FIG. 14A, similar to the eight of diamonds, the mark in the central row also starts to be visible in the distinctive portion C on the seven of diamonds as illustrated in FIG. 15B, so that whether the card is the seven of diamonds or the eight of diamonds cannot be confirmed in this state.

Hence, if the upward/downward orientation of a dealt card is randomly determined, the user does not know whether the card is dealt in the orientation as in FIG. 14A or in the orientation as in FIG. 15B and thus cannot confirm whether it is the six of diamonds, the seven of diamonds, or the eight of diamonds at the stage of squeezing to the solid lines S1. Then, only at the stage where the squeezing is performed to the positions of broken lines S1′ in FIG. 14A and whether there is the second mark in the central row in the distinctive portion C can be determined, whether the card is the six of diamonds, the seven of diamonds, or the eight of diamonds can be confirmed.

The CPU 202 sets the squeezing direction of the cards to a fixed direction as illustrated with the arrow in the vicinity of the card with the six of diamonds.

In a case of the diagonal squeezing, the squeezing direction is set to a direction intersecting with both the short sides and the long sides of the cards as the phrase “diagonal squeezing” literally means. Furthermore, the squeezing direction is set such that the distinctive portion C appears as late as possible in the diagonal squeezing.

To be specific, as illustrated in each of FIGS. 14A, 14B, 15A and 15B, if the diagonal squeezing is performed with the card placed diagonally right-up, the squeezing direction is set such that the diamond mark close to the upper side in the left row and the diamond mark close to the lower side in the right row appear last in the squeezing motion. If the diagonal squeezing is performed with the card placed diagonally left-up, the squeezing direction is set such that the diamond mark close to the upper side in the right row and the diamond mark close to the lower side in the left row appear last in the squeezing motion. Such setting of the squeezing direction can delay appearance of the distinctive portion C in the squeezing motion.

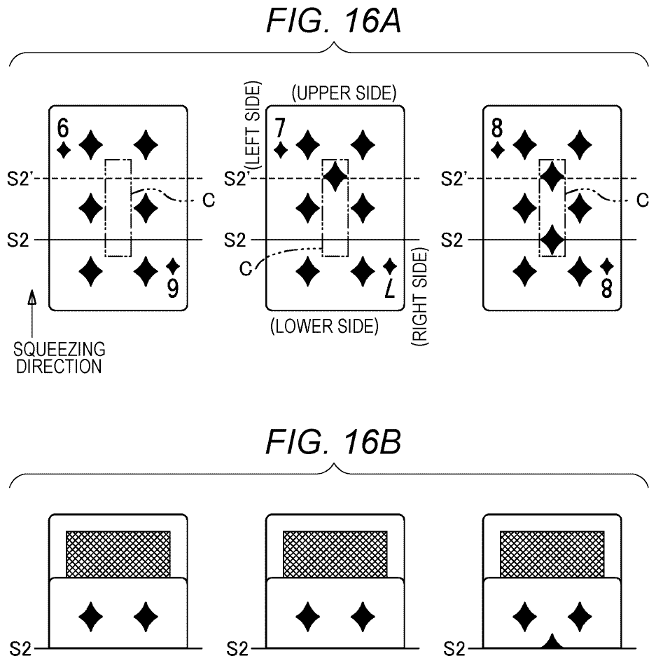

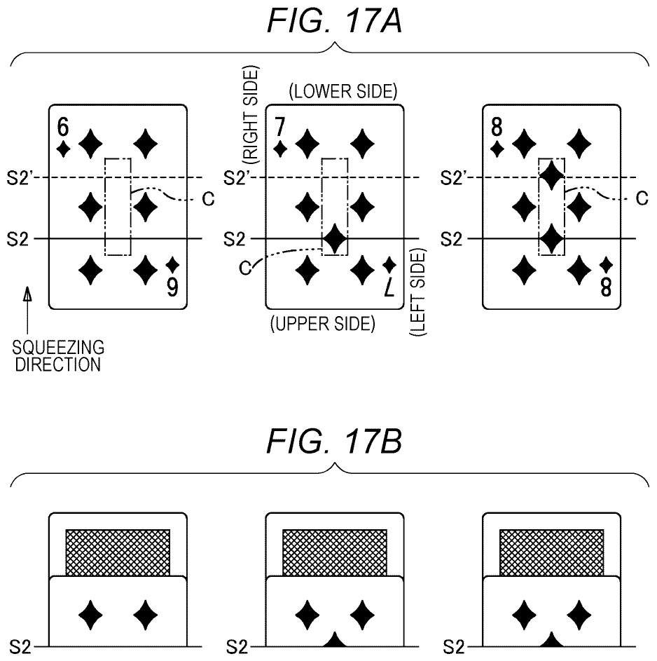

FIGS. 16A, 16B, 17A and 17B are diagrams for describing how the cards are seen when the vertical squeezing is performed to the cards from lower short sides. FIGS. 16A and 17A respectively illustrate cases where the cards are dealt in the same upward/downward orientations as those in FIGS. 14A, 14B, 15A and 15B described above, and FIGS. 16B and 17B illustrate states where the vertical squeezing is performed to solid lines S2 in the respective drawings.

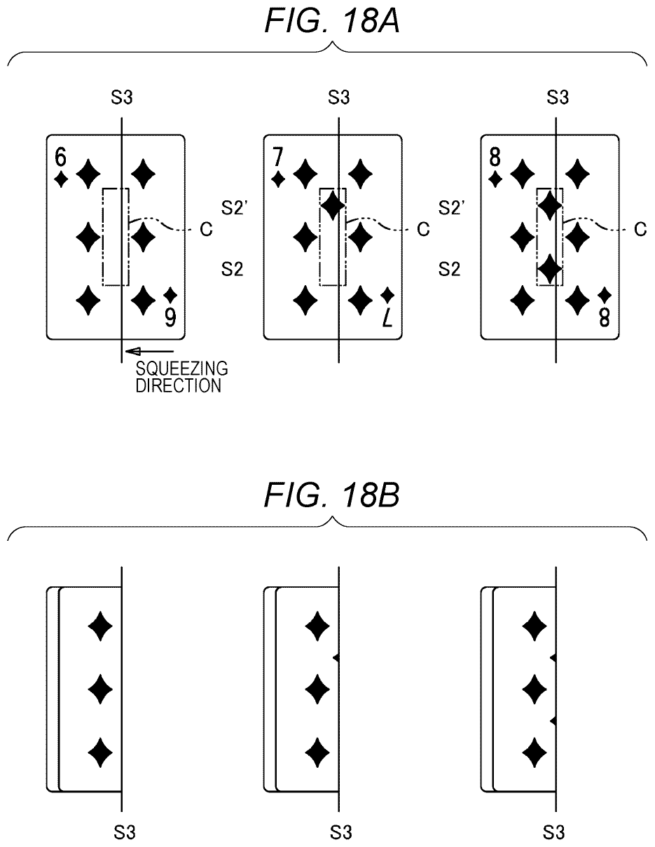

In addition, FIGS. 18A and 18B are diagrams for describing how the cards are seen when the horizontal squeezing is performed. FIG. 18A illustrates a case where the cards are dealt, and FIG. 18B illustrates a state where the horizontal squeezing is performed to the cards to solid lines S3.

Even in the vertical squeezing and the horizontal squeezing, the CPU 202 sets fixed squeezing directions of the cards as illustrated in FIGS. 16A to 18B. To be specific, in a case of the vertical squeezing, the squeezing direction is defined parallel to the long sides of the cards. For the horizontal squeezing, the squeezing direction is defined parallel to the short side direction of the cards. Such setting of the squeezing direction delays the timing at which the distinctive portion C appears in the squeezing motion, the most. The squeezing direction is fixed, not variable, which prevents the distinctive portion C from appearing at unintended timing during the squeezing to spoil the fun.

If the card is in the orientation illustrated in FIG. 16A, the lower diamond mark in the central row in the distinctive portion C starts to be visible on the eight of diamonds in the same drawing FIG. 16B. Thus, if it is known that the card is dealt in the orientation as in FIG. 16A, the card can be confirmed to be the eight of diamonds at this stage; however, if the diamond mark in the central row is not visible, whether it is the six of diamonds or the seven of diamonds cannot be confirmed.

However, if, as illustrated in FIG. 17A, the seven of diamonds is upside down from that in FIG. 16A, similar to the eight of diamonds, the mark in the central row in the distinctive portion C also starts to be visible on the seven of diamonds as illustrated in FIG. 17B, so that whether the card is the seven of diamonds or the eight of diamonds cannot be confirmed in this state.

Hence, if the upward/downward orientation of a dealt card is randomly determined, the user does not know whether the card is dealt in the orientation as in FIG. 16A or in the orientation as in FIG. 17A and thus cannot confirm whether it is the six of diamonds, the seven of diamonds, or the eight of diamonds at the stage of squeezing to the solid lines S2. Then, only at the stage where the squeezing is performed to the positions of broken lines S2′ in FIG. 16A and whether there is the second mark in the central row can be determined, whether the card is the six of diamonds, the seven of diamonds, or the eight of diamonds can be confirmed.

In this way, in the present embodiment, the upward/downward orientation of a dealt card is randomly determined so that the user cannot know the upward/downward orientation, which can delay the timing at which the card type can be confirmed through the squeezing motion. This increases uncertainty of the card type that the user can recognize in the process of performing the squeezing motion and can thus increase the sense of thrill until the card type can be confirmed while the card is turned over, which can further increase the excitement over the squeezing motion in the card game.

Furthermore, the direction is fixed for each rotation orientation in this way, which can save the amount of storage of card images and can speed up image processing. The processing speed of the game can be increased, which can prevent time lag between operation and screen display and provide comfortable game operation.

### Other Effects of the Present Embodiment

(1) The squeezing motion to a card displayed on the user display device 102 includes the diagonal squeezing, the vertical squeezing, and the horizontal squeezing, and the start position of the squeezing motion is a lower portion of the card in any squeezing method. In the present embodiment, when a distributed card is displayed on the user display device 102, a lower portion of the card on the screen is displayed while being turned to the extent that the design on the card front surface is not seen. That is, a portion where the squeezing motion should be started is displayed while being turned, which can indicate, to the user, the position where the squeezing motion is performed and promote the squeezing motion.

Note that, if the start position of the squeezing motion is not a lower portion of a card because of the type of card game, custom, or the like, display of a portion, corresponding to the start position, of the card turned face up can obtain an effect similar to that of the present embodiment.
(2) The user may prefer any squeezing method among the diagonal squeezing, the vertical squeezing, and the horizontal squeezing as the squeezing motion to a card, and which squeezing method can be performed is determined by the rotation orientation of a distributed card. In the present embodiment, the card rotation orientation when the user first performs the squeezing motion is stored, and, in the next play, a card is displayed in the stored card rotation orientation on the user display device 102. Thus, if the user selects an orientation in which the preferred squeezing method can be performed in the first play when playing a plurality of games successively, a card is dealt in the rotation orientation matching the squeezing method preferred by the user from the next play onward. With this, the user can perform the squeezing motion in the preferred squeezing method without performing a card rotation motion in each round of play and can concentrate on the squeezing motion, which is the most exciting part of the game.

### Modifications

(1) The above-described embodiment has described a case where the card game apparatus 100 is an apparatus for playing baccarat using playing cards; however, no such limitation is intended. The present invention can be applied to a card game that involves a squeezing motion of gradually turning over, from an end, a card distributed face down such that the back surface can be seen and in which the winner is determined in accordance with the score or other designs on the card front surface. Furthermore, cards used are not limited to playing cards, and application to a card game using other cards is possible.
(2) In the above-described embodiment, on the assumption that rectangular playing cards are used, the upward/downward orientation as the card orientation in the present invention is randomly determined when the card is distributed. However, regarding the card orientation, in the case of a game using, for example, square cards, any of the four orientations, upward, downward, left, and right, may be randomly determined. In the case of using, for example, hexagonal cards, any of the six orientations may be randomly determined. In the case of using circular cards, any orientation may be randomly determined. In short, if there are a plurality of orientations that cannot be distinguished just by looking at the back surface of a card, which orientation the card is distributed in may be randomly determined as the card orientation.
(3) In the above-described embodiment, the display device provided to the card game apparatus 100 is separated into the dealer display device 101 and the user display device 102; however, no such limitation is intended. A display device may be common to the dealer side and the user side, and a display region on the dealer side and a display region on the user side may be disposed on a screen of the display device.
(4) The above-described embodiment has described a case where the card game apparatus 100 is a stand-alone apparatus having the processing function necessary for the game and including the display devices 101 and 102 (touch panels also serving as input devices); however, no such limitation is intended. The card game apparatus of the present invention may be configured, for example, as a server connected to a network, such as the Internet, the user may access the server from a computer terminal, the server may receive various operations on the user terminal via the network, and a display screen for the user may be transmitted from the server to the user terminal via the network.

Examples of the combinations of disclosed technical characteristics are described below.
(1) A card game apparatus including:
a CPU, in which
the CPU executes
   display processing of generating an image of a card having a design depicted on a front surface and indicating a card type in a state where the card faces down and is rotated in a rotation orientation in a plane of the card, and
   a squeezing motion of displaying the image of the card in such a manner that the card is gradually turned face up from an end of the card toward a squeezing direction, and
a position of the end and the squeezing direction of the card are set in a direction determined for the rotation orientation.
(2) The card game apparatus according to (1), in which the design has a distinctive portion allowing the card type to be confirmed, the card specifies a first direction parallel to a long side of the card and a second direction orthogonal to the first direction, and when the squeezing direction intersects with both the first direction and the second direction, the CPU sets the squeezing direction such that the distinctive portion is displayed last in the squeezing motion.
(3) The card game apparatus according to (1) or (2), in which the CPU further executes operation processing of receiving a user operation and changes speed of the squeezing motion in response to the operation.
(4) The card game apparatus according to any one of (1) to (3), in which the CPU sets a region to at least one of the card and a vicinity of the card in the display processing and executes the operation processing when the operation is performed on the region.
(5) The card game apparatus according to any one of (1) to (4), in which the front surface further includes an index indicating the card type, and the CPU does not display the index in the squeezing motion.
(6) The card game apparatus according to any one of (1) to (5), in which, when an area of the front surface displayed face up exceeds a threshold in the squeezing motion, the CPU displays the entire front surface face up.
(7) A program causing a computer to execute: display processing of generating an image of a card having a design depicted on a front surface and indicating a card type in a state where the card faces down and is rotated in a rotation orientation in a plane of the card; and a squeezing motion of displaying the image of the card in such a manner that the card is gradually turned face up from an end of the card toward a squeezing direction, in which a position of the end and the squeezing direction of the card are set in a direction determined for the rotation orientation.
(8) A recording medium having the program according to (7) recorded therein.

1. A method comprising:
generating, on a touch display, an image of a card having a face surface with a pattern indicating a card type, the card oriented with the face surface down and in a rotational orientation within the plane of the card;
detecting user contact in a predetermined region of the touch display, wherein the predetermined region includes at least one of an area of the card and an area surrounding the card; and
displaying the image of the card by
reading a target predetermined card shape corresponding to the rotational orientation from a memory that stores a plurality of predetermined card shapes, each predetermined card shape setting an edge and a squeeze direction according to the rotational orientation, and
mapping a face surface image to the target predetermined card shape such that an area of the face surface is shown from the edge of the card toward the squeeze direction until a line, in the plane of the card, perpendicular to the squeeze direction.

2. The method according to claim 1, wherein each predetermined card shape among the plurality of predetermined card shapes corresponds to one of a horizontal orientation, a vertical orientation, a diagonal rising to the right orientation, and a diagonal rising to the left orientation.

3. The method according to claim 2, wherein the rotational orientation of each of the diagonal rising to the right orientation and the diagonal rising to the left orientation is such that the squeeze direction maximizes delay until the card type is revealed.

4. The method according to claim 1, wherein a distance between the edge and the line is in accordance with a squeeze degree based on the user contact.

5. The method according to claim 4, further comprising:
displaying the image of the card with the face surface up in response to the squeeze degree exceeding a threshold degree.

6. The method according to claim 5, wherein
the threshold degree is exceeded in response to the area of the face surface that is shown rendering the card type determinable.

7. The method according to claim 6, wherein
the card is selected from among a plurality of cards, each card among the plurality of cards having a unique card type indicated by one of a unique symmetrical pattern or a unique asymmetrical pattern, and
the threshold degree is not uniform among the plurality of cards.

8. The method according to claim 5, wherein
the asymmetrical pattern includes a distinctive part that indicates the card type,
the symmetrical defines a first direction along a length of the card and a second direction orthogonal to the first direction, and
when the squeeze direction intersects both the first direction and the second direction, the distinctive part is hidden until the threshold degree is exceeded.

9. The method according to claim 5, wherein:
the asymmetrical pattern includes an index indicating the card type, and
the index is not reproduced in the area of the face surface that is shown during displaying of the image of the surface of the card until displaying the image of the card with the face surface up.

10. The method according to claim 1, wherein
the user contact is continuously detected, and
the area of the face surface that is shown is continuously changed in accordance with a change in the user contact.

11. The method according to claim 1, wherein an orientation of the asymmetrical pattern with respect to the symmetrical shape is randomly determined.

12. An apparatus comprising:
a controller comprising circuitry configured to perform operations comprising:
generating, on a touch display, an image of a card having a face surface with a pattern indicating a card type, the card oriented with the face surface down and in a rotational orientation within the plane of the card;
detecting user contact in a predetermined region of the touch display, wherein the predetermined region includes at least one of an area of the card and an area surrounding the card; and
displaying the image of the card by
reading a target predetermined card shape corresponding to the rotational orientation from a memory that stores a plurality of predetermined card shapes, each predetermined card shape setting an edge and a squeeze direction according to the rotational orientation, and
mapping a face surface image to the target predetermined card shape such that an area of the face surface is shown from the edge of the card toward the squeeze direction until a line, in the plane of the card, perpendicular to the squeeze direction.

13. The apparatus according to claim 12, wherein each predetermined card shape among the plurality of predetermined card shapes corresponds to one of a horizontal orientation, a vertical orientation, a diagonal rising to the right orientation, and a diagonal rising to the left orientation.

14. The apparatus according to claim 13, wherein the rotational orientation of each of the diagonal rising to the right orientation and the diagonal rising to the left orientation is such that the squeeze direction maximizes delay until the card type is revealed.

15. The apparatus according to claim 12, wherein a distance between the edge and the line is in accordance with a squeeze degree based on the user contact.

16. The apparatus according to claim 15, wherein the operations further comprise:
displaying the image of the card with the face surface up in response to the squeeze degree exceeding a threshold degree.

17. A non-transitory computer-readable medium having instructions stored thereon that, when executed by one or more processors, perform operations comprising:
generating, on a touch display, an image of a card having a face surface with a pattern indicating a card type, the card oriented with the face surface down and in a rotational orientation within the plane of the card;
detecting user contact in a predetermined region of the touch display, wherein the predetermined region includes at least one of an area of the card and an area surrounding the card; and
displaying the image of the card by
reading a target predetermined card shape corresponding to the rotational orientation from a memory that stores a plurality of predetermined card shapes, each predetermined card shape setting an edge and a squeeze direction according to the rotational orientation, and
mapping a face surface image to the target predetermined card shape such that an area of the face surface is shown from the edge of the card toward the squeeze direction until a line, in the plane of the card, perpendicular to the squeeze direction.

18. The computer-readable medium according to claim 17, wherein each predetermined card shape among the plurality of predetermined card shapes corresponds to one of a horizontal orientation, a vertical orientation, a diagonal rising to the right orientation, and a diagonal rising to the left orientation.

19. The computer-readable medium according to claim 18, wherein the rotational orientation of each of the diagonal rising to the right orientation and the diagonal rising to the left orientation is such that the squeeze direction maximizes delay until the card type is revealed.

20. The computer-readable medium according to claim 17, wherein a distance between the edge and the line is in accordance with a squeeze degree based on the user contact.
